(19) United States
(12) Patent Application Publication
(10) Pub. No.: US 2025/0329506 A1
(43) Pub. Date: Oct. 23, 2025

(54) Keyboard with movable rows of keys

(71) Applicants: Timothy Frank Bernasch, St Catharines (CA); Ahmed Abdullahi Omar, Toronto (CA)

(72) Inventors: Timothy Frank Bernasch, St Catharines (CA); Ahmed Abdullahi Omar, Toronto (CA)

(21) Appl. No.: 19/182,603

(22) Filed: Apr. 18, 2025

Related U.S. Application Data
(60) Provisional application No. 63/636,490, filed on Apr. 19, 2024.

(51) Int. Cl. H01H 13/7057; H01H 13/10; H01H 13/18; H01H 13/70

(52) U.S. Cl. CPC H01H 13/7057; H01H 13/10; H01H 13/18; H01H 13/7013

(57) ABSTRACT

A keyboard is disclosed for allowing the manipulation of the position of its key rows with respect to its base so that a key layout may be customized to a user's preference. The keyboard includes a base, at least one key row, and at least one key base. The base includes a tray formed therein. The at least one key row is disposed within the tray and includes a plurality of keys linearly arranged along a first direction. The at least one key base connects the at least one key row to the base and is configured to move the at least one key row along the first direction with respect to the base.

### FIELD OF THE INVENTION

The present embodiments described in this specification relate generally to a computer keyboard optimized for gaming. More specifically, the embodiments relate to a computer keyboard with moveable key rows.

### BACKGROUND

Even though using a keyboard sideways seems impossible, some people do it to play games. The key spacing of a keyboard can cause gamers to tilt their keyboard to reach all the keys.

When it comes to more complex games with many features to consider, a player needs to be able to navigate their keyboard quickly and with ease. The button-mapping of some games can become spread out very far across the keyboard. Some players can find themselves struggling to move from one key to another because of the distance between them or the positioning of their playing hand.

To circumvent this, many players will tilt their keyboards to a more optimal position. A change in the angle of their keyboard allows gamers to reach more keys. Often, this shift also positions the fingers on the other hand to be able to reach keys better.

For example, while most games make use of the WASD keys for navigation and movement, some games also use the QER keys for specific movements and actions. Having the keyboard tilted allows the player to access the latter of these sets of keys easier because they are more in line with the natural position of fingers; there is less distance to reach to the keys, or the angle to reach them is more comfortable.

One such game that makes use of these keys is Tom Clancy's Rainbow Six: Siege™, one of the most popular games in the world of professional gaming and eSports. Unlike a lot of other FPS's (First Person Shooter games), in addition to standard movement, “Siege” also features a “lean” feature which the player can use to peek around corners or hold different angles.

The additional movements require additional keyboard functionality, and the default button-mapping for “lean” has the Q and E keys for leaning left and right, respectively. Since rotating the keyboard can improve the reach to these important keys, many players play with a rotated keyboard.

The popular videogame Fortnite™ is another example where there are many different key assignments to do things like moving, building, editing and switching weapons. Professional players need to do these things in very quick succession. Many professional Fortnite players that play with a keyboard rotate their keyboard almost completely vertical, which provides better reach for their thumb.

Another problem gamers experience is with their mouse. A mouse is a significant contributor to the lack of space in a gamers play area. Not only can mouse mats be quite large, but the mouse itself requires a lot of space to use as it is always in motion. In competitive gaming, a mouse's area of movement takes up a huge amount of space. This was solved with the creation of smaller size keyboards, such as “tenkeyless” keyboards. A tenkeyless mechanical keyboard is essentially a standard full-sized keyboard without a ten-key number pad, thus allowing for more space for the gamer's mousepads. However, this created another problem where the ten keyless keyboards lack a dedicated number pad. Some companies have solved this with a separate numpad that can be purchased or a number pad that can be attached to the tenkeyless keyboard.

“Standard” keyboards have their keys in what is called a “staggered” arrangement, where each row of keys is offset from the rows above and below it. But some people, such as gamers, prefer to use “ortholinear” keyboards, which are becoming more common. The ortholinear key layout has all the keys in laid out in perfect rows and columns with no offset.

Until now, keyboards have been manufactured with the keys in a particular arrangement, be it staggered, ortholinear, or tenkeyless. People sometimes buy different keyboards for different purposes. Accordingly, there is a need for a single keyboard that could change its layout to suit different uses.

### SUMMARY OF THE INVENTION

A keyboard is disclosed which is configured to allow for manipulation of the position of its key rows with respect to its base so that a key layout may be customized to a user's preference.

In an embodiment, a keyboard includes a base, at least one key row, and at least one key base. The base includes a tray formed therein. The at least one key row is disposed within the tray and includes a plurality of keys linearly arranged along a first direction. The at least one key base connects the at least one key row to the base and is configured to move the at least one key row along the first direction with respect to the base.

In an embodiment, the at least one key row is moveable with respect to the base by electronic means, such as an electric motor.

In alternative embodiments, the at least one key row is moveable with respect to the base by manual means, such as having a lever or slide that is manipulatable by a user.

These and other features and advantages will become apparent from the following detailed description of the presently preferred embodiment(s), taken in conjunction with the accompanying drawings.

### BRIEF DESCRIPTION OF DRAWINGS

The drawings reference herein forms a part of the specification. Features shown in the drawings are meant as illustrative of only some embodiments, and not of all embodiments unless otherwise explicitly indicated.

These and other features and advantages will become apparent from the following detailed description of the presently preferred embodiment(s), taken in conjunction with the accompanying drawings.

FIG. 1A depicts a perspective view of a keyboard with moveable key rows in a first arrangement, in accordance with an embodiment of the invention.

FIG. 1B depicts a perspective view of a keyboard with moveable key rows in a second arrangement, in accordance with an embodiment of the invention.

FIG. 1C depicts a perspective view of a keyboard with moveable key rows in a third arrangement, in accordance with an embodiment of the invention.

FIG. 1D depicts a perspective view of a keyboard with moveable key rows in a fourth arrangement, in accordance with an embodiment of the invention.

FIG. 2A depicts a perspective exploded view of a key row and a key base, in accordance with an embodiment of the invention.

FIG. 2B depicts a perspective view of a key row attached to a key base, in accordance with an embodiment of the invention.

FIG. 3A depicts a top view of a motor and screw gear assembly, in accordance with an embodiment of the invention.

FIG. 4A depicts an perspective exploded view of a key row and key base and motor with screw gear assembly, in accordance with an embodiment of the invention.

FIG. 4A depicts an perspective view of an assembled key row and key base and motor with screw gear assembly, in accordance with an embodiment of the invention.

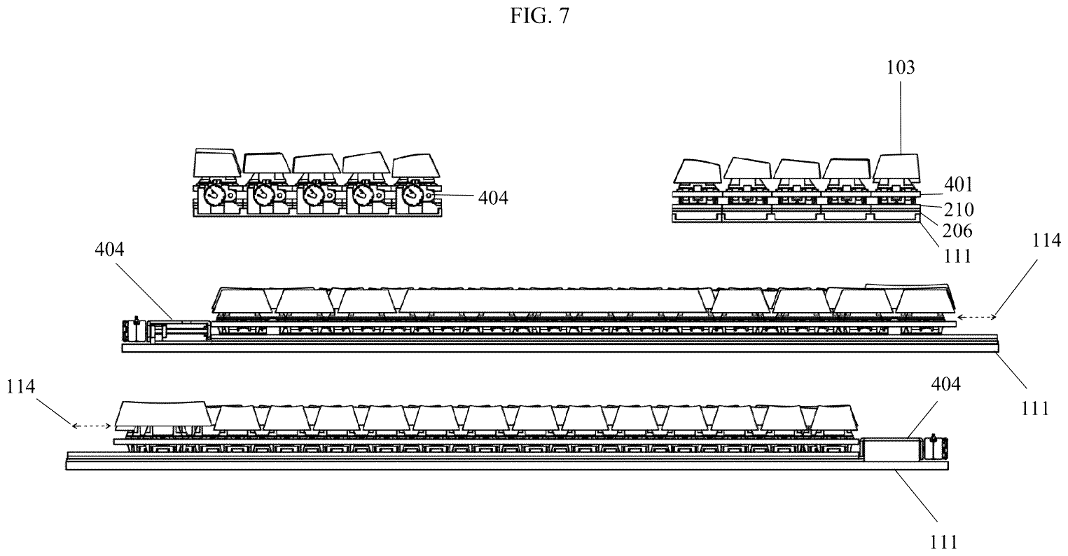

FIG. 3A shows a side view of a servo and screw gear assembly, in accordance with an embodiment of the invention.

FIG. 5 depicts a perspective view of a base with a tray having channels to receive key bases, in accordance with an embodiment of the invention.

FIG. 6A depicts a perspective view of a base with a tray and a key row attached to a key base and motor with lead screw assembly, showing where the key row would be placed within the tray and where the motor with lead screw assembly would attach to the motor attachment point, in accordance with an embodiment of the invention.

FIG. 6B depicts a perspective view of a base with five key rows and key bases and five motors with lead screw assemblies disposed within the tray and along five channels, in accordance with an embodiment of the invention.

FIG. 7 depicts side views of all four sides of five key rows and key bases disposed within a tray, in accordance with an embodiment of the invention.

FIG. 8A depicts a perspective view of a base with a key row and key base disposed within the tray and along a channel and a limit switch disposed within the tray, in accordance with an embodiment of the invention.

FIG. 8B depicts a perspective view of a base with a key row and key base disposed within the tray and along a channel and a magnet attached to the key row and an electronic position sensor disposed within the tray, in accordance with an embodiment of the invention.

FIG. 9A depicts a perspective view of a base with five channels with five key rows and key bases disposed within the tray and each along a channel and manual hand screw disposed within each channel.

FIG. 9B depicts a perspective view from behind of a key base with 5 channels with holes to access a manual hand screw in each channel from the back of the tray.

### DETAILED DESCRIPTION OF EMBODIMENTS

It will be readily understood that the components of the present embodiment(s), as generally described and illustrated in the Figures herein, may be arranged and designed in a wide variety of different configurations. Thus, the following detailed description of the embodiments of the apparatus, system, and method of the present embodiment(s), as presented in the Figures, is not intended to limit the scope of the embodiment(s), as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment described herein. Thus, appearances of the phrases “a select embodiment,” “in one embodiment,” or “in an embodiment” in various places throughout this specification are not necessarily referring to the same embodiment.

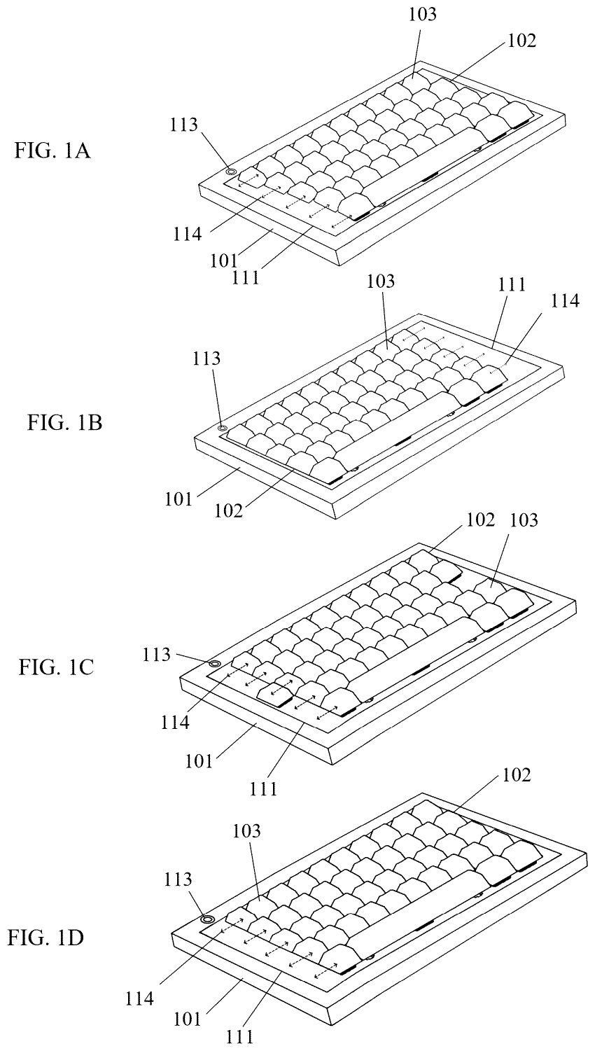

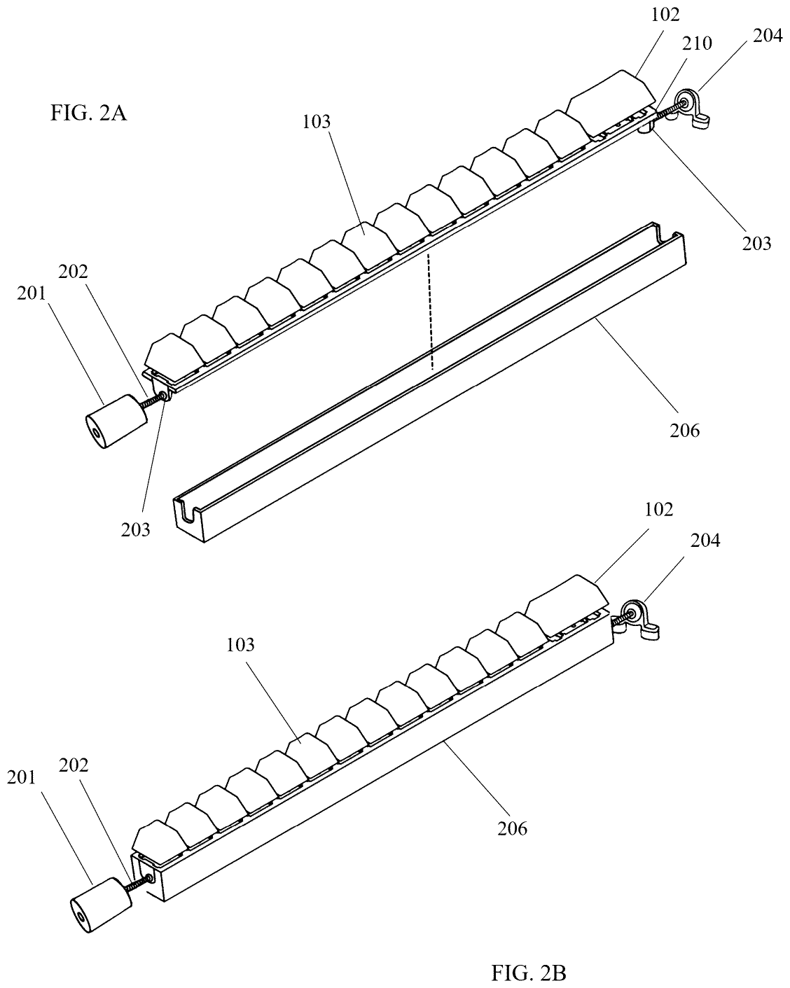

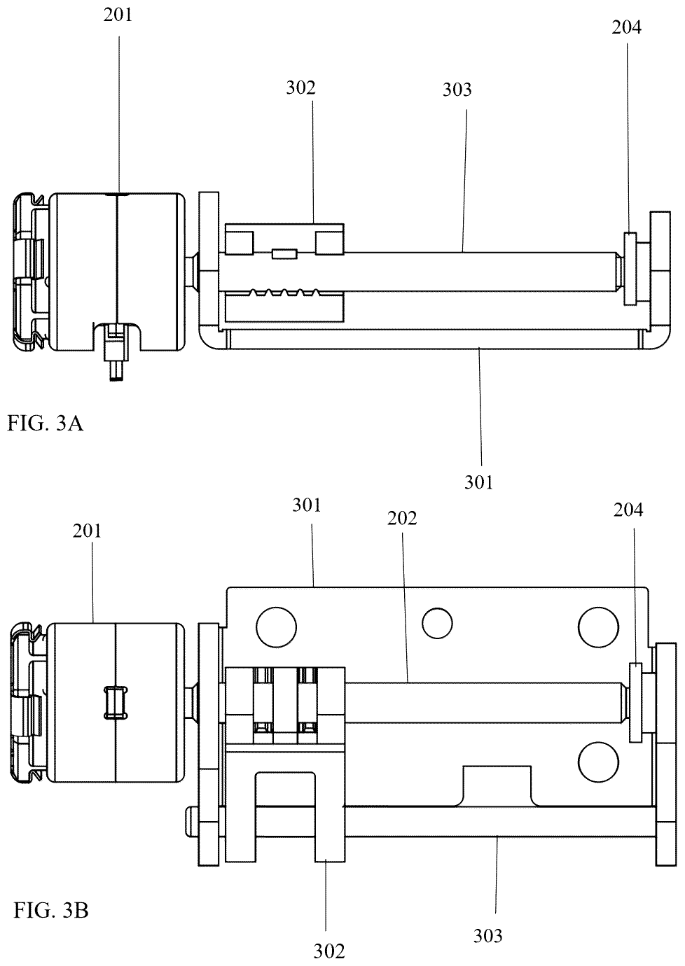

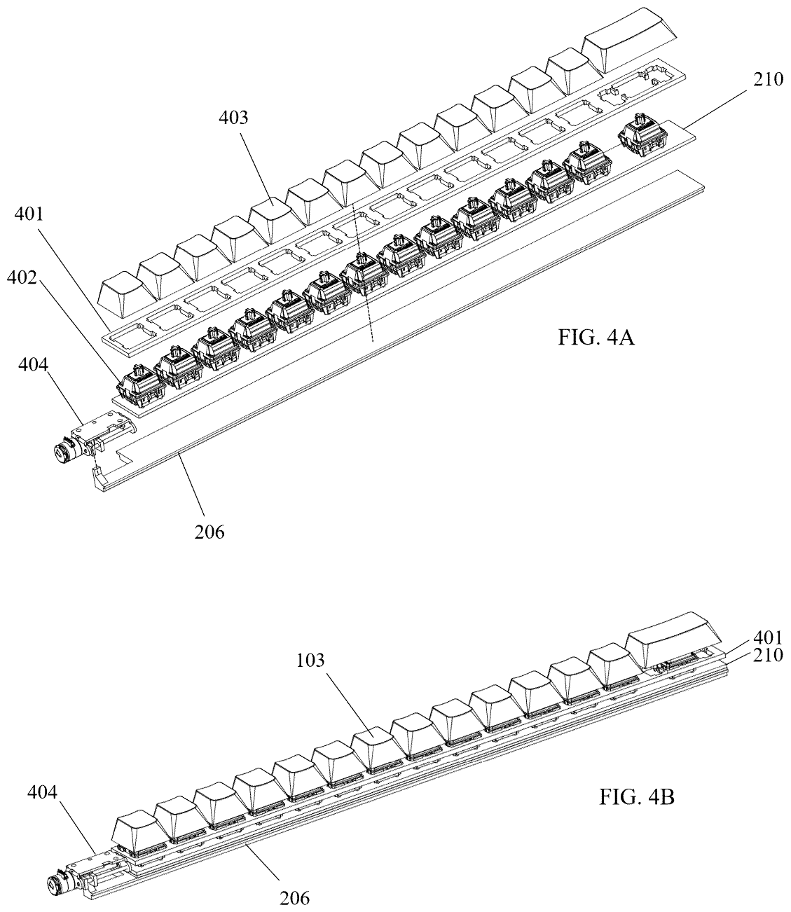

FIGS. 1A-1D shows an embodiment of a keyboard with 3 movable key rows with the rows in various positions. For an English language keyboard, 3 rows is the minimum needed to accommodate 26 letters, but there may be 5 or more rows on an embodiment of a standard “full” keyboard, particularly a bottom spacebar row and top number row is almost ubiquitous. The keyboard base (101) is stationary and sits near a computer or game console, usually on a flat surface using any available method already common in the field of keyboard design (it may have rubber feet, angle adjustment, etc). Within the stationary body, a tray (111) is formed, and in the tray sits one or more movable rows of keys (102). A movable row of keys consists of a key row coupled with a key row base. The key row consists of one or more individual keys (103) arranged in a row, which are attached at the bottom to a PCB or bracket (210) to form a key row (110). A key row (110) has a key row base (106) attached to the bottom of it which forms a movable row of keys (102). The movable row of keys makes contact with the tray (111) and slides within the tray (111) along a first direction (114). The movable row of keys (102) is mechanically linked to a means of movement such as a motor (201) or a manual knob (901) or lever. Each key row is independently able to slide horizontally within the tray (111) of the keyboard body (101) along a first direction (114) so that different key staggering arrangements can be formed. FIG. 1A shows a standard staggered arrangement, FIG. 1B shows an ortholinear arrangement shifted all the way to the left and FIG. 1C a custom arrangement which is possible, and FIG. 1D shows an ortholinear layout shifted to the right. In an embodiment where the means of key row movement is a motor, the position of the key rows may be controlled by one or more electronic buttons (113) that are located on the top surface of the keyboard base. Pressing the button commands electronic circuits to move the motors which move the key rows along the first direction until a desired position is reached.

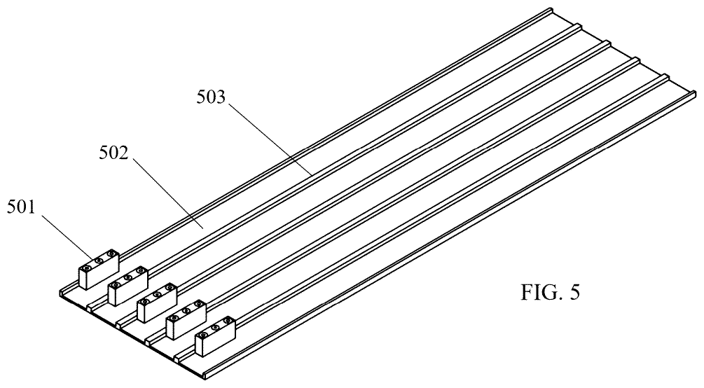

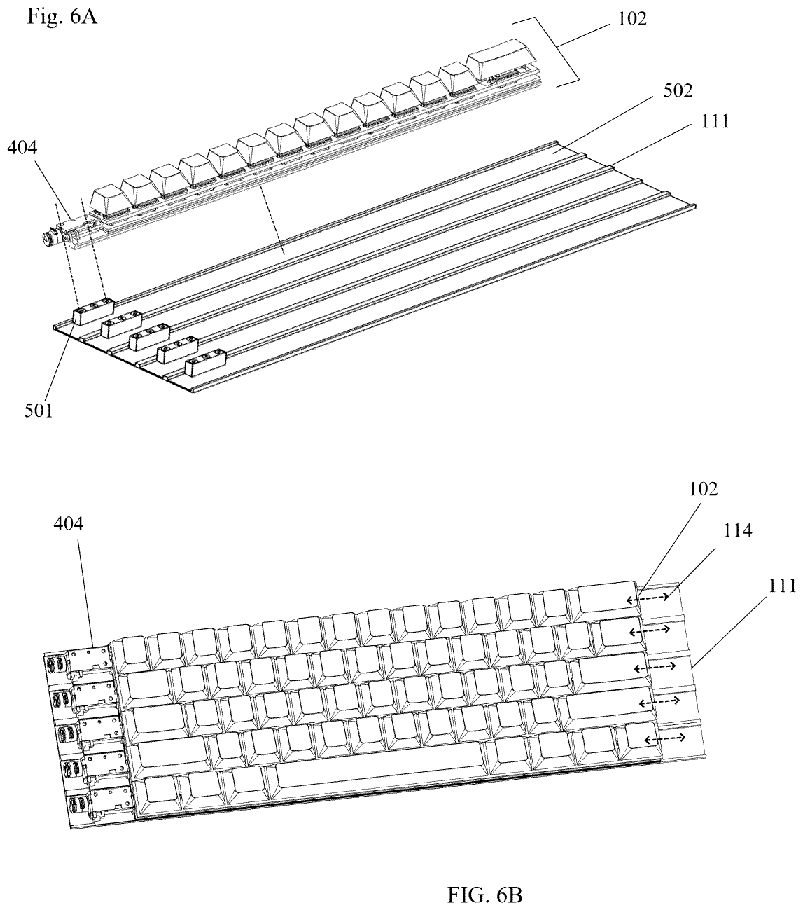

FIGS. 2A and 2B show a detail of one embodiment of a movable key row assembly. In this embodiment a motor (201) or a similar electronic means of movement is coupled to a threaded rod (202). The motor component may be a brushed or brushless motor, or it may be be a stepper motor or any other electronics means of movement. The motor may contain an internal gear reduction and it may have integral position sensing. The motor may be coupled to a mechanism that transmits the rotational force of the motor, such as a gear. In one embodiment the gear takes the form of a threaded rod. The threaded rod (202) is coupled to the motor and it is engaged with one or more threaded mounting brackets (203). The arrangement of a threaded rod engaged with a threaded mounting bracket (also known as a “carriage”) is known in the industry as a lead screw. The one or more threaded mounting brackets are firmly attached to points on the key row bracket or PCB (210). In other embodiments, the attachment of the one or more threaded bracket may be to the key row base (206). Either of these arrangements will achieve the goal of coupling the lead screw assembly to the movable row of keys (102) The threaded rod (202) may be supported on the opposite end of the movable key row by a bearing or bushing (204), or it may be shorter than the movable key row and therefore have no support on the other end. The key row can be moved back and forth in the first direction (114), by the action of the threaded rod (202) engaging with the one or more threaded brackets (203) which is rotated by the motor (201).

To support the key row and protect the mechanical and electrical and mechanical components from the downward force of pressing on the keys during use, the key row (103) has a key base (206) along its entire length which contacts the surface underneath and transmits the downward force of key presses through the bracket or PCB (210) into the keyboard base. In an embodiment, the key row has a bottom piece (206) in the shape of a cap or enclosure that encloses the threaded rod (202) and supports the entire edge of the bottom of the PCB or bracket (210). The bottom of the PCB or bracket (210) is a delicate surface and it may also have electrical leads from the key switches (402) sticking out of it, so it is not a suitable surface for the movable key row to slide on, even in embodiments where there is no threaded rod (202) under the key row (110). The key row base (206) provides a suitable sliding surface to the movable row of keys.

FIG. 3A shows a side view and FIG. 3B shows a top view of a motor and lead screw assembly. This type of assembly may be obtained as an “off the shelf” unit that can facilitate linear movement. In an embodiment of the keyboard with movable rows of keys, this type of component can be linked to the movable row of keys (102) to move it along the first direction (114). This motor and lead screw assembly has a motor (201) with the shaft connected to a threaded rod (202) and the motor body is connected to a stationary bracket (301). The bracket (301) is connected to a bearing or bushing (204) to support the other end of the threaded rod. The threaded rod (202) is engaged with a carriage (302) which travels along the threaded rod when the motor (201) spins the threaded rod (202). In some embodiments such as the one shown in FIG. 3, there may also be also a guide rail (303) that the carriage is attached to and which is attached to the bracket. This carriage (302) may be attached to the movable row of keys (102) to move it along the first direction (114).

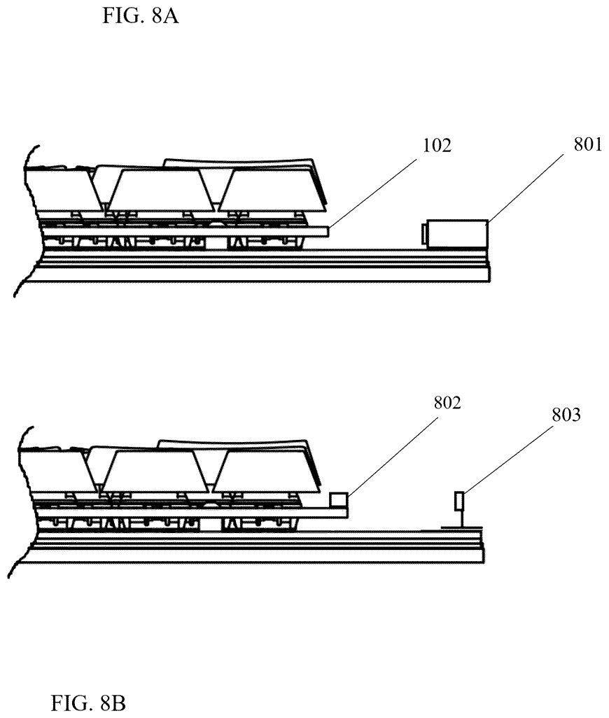

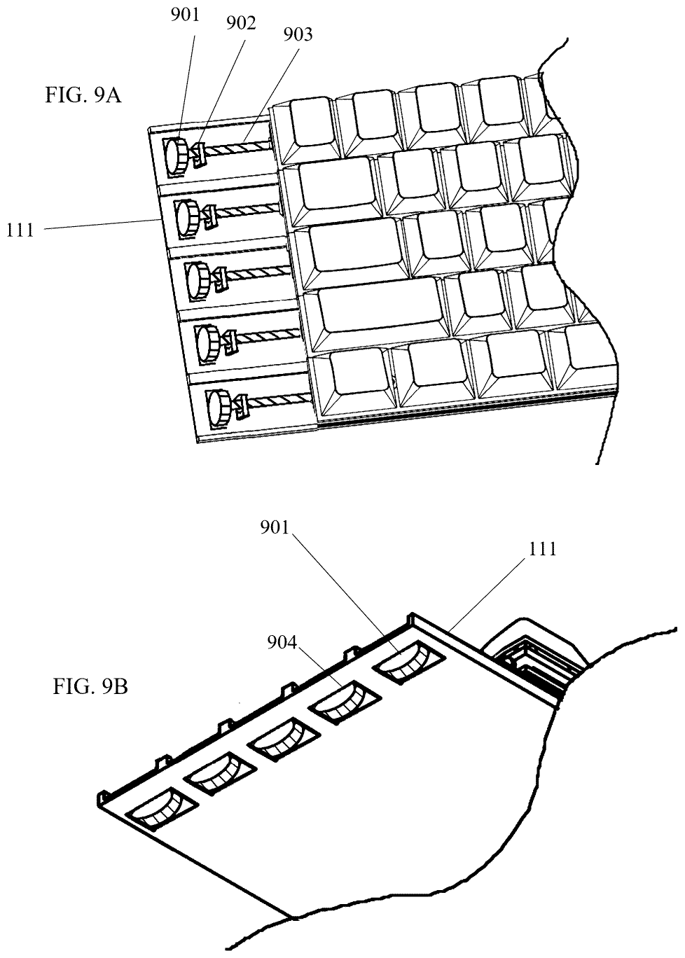

FIG. 4A shows an exploded view, and FIG. 4B shows an assembled view of an embodiment of a movable row of keys and motor with lead screw. In this embodiment, the one or more keys arranged in a row (103) are attached to a bracket or PCB (210). The one or more keys in a row further consist of a key switch (402) and a key cap (403) which are connected together to form each key. In this embodiment, there is a stabilizing bracket (401) that is connected to the key switches. This type of bracket is commonly used in keyboards and provides additional stability to the keys. The stabilizing bracket (401) may also be connected to the bracket or PCB (210) for additional stabilization. The key row assembly is connected to the key base (206). The key base is connected to the carriage (302) of the motor and lead screw assembly (404). In other embodiments the PCB or bracket (210) may be connected to the carriage (302) instead.

FIG. 5 shows a detail of the tray (111). This tray may be formed on or in the keyboard base (101). In a minimal implementation of a keyboard base, the keyboard base may be reduced to little more than the tray. The tray has a mechanical function. The motor is connected to the tray at a connection point (501). The top surface of the tray (502) is the sliding surface on which the one or more movable rows of keys (102) slide on when they move. In some embodiments there may be ridges (503) formed into the bottom surface to help guide the movable rows of keys.

FIG. 6A shows the assembly of a movable key row assembly (102) and the motor with lead screw assembly (404) into the keyboard base tray (111). The movable key row (102) rests on the top surface (502) of the tray and the motor with lead screw assembly (404) attaches to the motor connection point (501). FIG. 6B shows one movable key row assembly (102) and motor with lead screw assembly (404) fully installed into the keyboard base tray (111). The moveable key row (102) can move along the first direction (114) when the motor is activated.

FIG. 7 shows side views of an assembled keyboard with multiple moveable rows of keys from all 4 sides.

FIG. 8A. shows how a limit switch (801) may be used at either end of the movable key row to detect when the movable key row has reached one end of the keyboard. When the movable key row (102) presses the limit switch, and electronic signal is sent to control circuitry to which will sense the position of the key row to be at one end of the keyboard. It can then use that information to help position the key row. Another way to achieve position sensing is an electronic magnetic sensor (803) and a magnet (802). The magnetic sensor senses the magnetic field of the magnet, and sends signals to the electronic control circuits. In this way it is possible to sense the position across a distance, and sense every position of the key row, not only the position when it is at one end.

FIG. 9A shows the top view and FIG. 9B shows the bottom view of an embodiment where the servo motor is replaced with a manual hand screw or thumb wheel (901) that can be manually turned to adjust the movable key row position. The screw may pass through a bushing or bearing (902) or other kind of support to keep it in pace and it may have threads (903) on it, much like the threaded rod. It may engage with the movable row of keys in a similar way to the threaded rod in the embodiment in FIG. 2A and FIG. 2B, by the use of a threaded bracket, forming a manually operated embodiment of a lead screw. The thumb wheel (901) may protrude out of an opening in the back of the keyboard tray (904) to allow adjustment of the keyboard. In other embodiments it may be adjustable from the front.

It is conceivable that there could also be other methods to move the key rows and fix their position, like a string or a chain or wire that moves through a motor in a loop similar to how a clothesline operates, or a linear motor or solenoid that uses magnetism to move back and forth without rotating. Also, pneumatics or hydraulics could be used as the actuation force. The lead screw gear mechanism could be replaced with a rack gear assembly, or any other suitable type of gearing.

Since the keyboard can have they keys rearranged between a standard staggered typing arrangement and an ortholinear arrangement, this also allows the keyboard with movable key rows to function as a standard keyboard for typing and quickly change to a standard numpad for number entry by using an ortholinear arrangement and alternate key functions, without having any extra keys for a numpad. A tenkeyless keyboard can switch to the ortholinear arrangement, and have specific keys doubling as numpad keys which will create a ten key numpad inside of a standard keyboard on demand.

They keyboard may also have stationary keys, or stationary rows; for example the “enter” key might span two rows on some embodiments. Also, staggered and ortholinear layouts are still possible if one of the rows is fixed and all of the other rows can move.

We claim:

1. A keyboard comprising:
a base including a tray formed therein;
at least one key row disposed within the tray, the at least one key row including a plurality of keys linearly arranged along a first direction;
at least one key row base connecting the at least one key row to the base, the at least one key base being configured to move the at least one key row along the first direction with respect to the base.

2. The keyboard of claim 1, further comprising at least one electric motor in mechanical communication with a gear and configured to move the at least one key row along the first direction with respect to the base.

3. The keyboard of claim 2, wherein the gear is a lead screw.

4. The keyboard of claim 2, further comprising at least one button in electronic communication with the electric motor.

5. The keyboard of claim 2, further comprising a limit switch disposed within the tray and configured to sense the position of the key row upon the limit switch being triggered.

6. The keyboard of claim 2, further comprising an electronic position sensor within the tray and configured to continuously sense the position of the key row.

7. The keyboard of claim 1, further comprising at least one hand screw in mechanical communication with a gear and configured to move the at least one key row along the first direction with respect to the base.

8. The keyboard of claim 7, wherein the gear is a lead screw.
